(19) United States
(12) Patent Application Publication
(10) Pub. No.: US 2007/0007264 A1
(43) Pub. Date: Jan. 11, 2007

(54) Hex mount for welding torch

(75) Inventor: Frank Zamuner, Oakville (CA)

Correspondence Address: FAY SHARPE / LINCOLN, 1100 SUPERIOR AVENUE, SEVENTH FLOOR, CLEVELAND, OH, 44114, US

(73) Assignee: Lincoln Global, Inc.

(21) Appl. No.: 11/178,819

(22) Filed: Jul. 11, 2005

(51) Int. Cl. B23K 9/28

(52) U.S. Cl. 219/137.31

(57) ABSTRACT

A mounting apparatus for a welding torch has a bracket having a body with an opening therein and first and second arms extending from the body. The opening of the body is hex-shaped and adapted to enable an associated welding torch to be mounted in various positions. A mounting arm has a first opening therethrough and is received between the first and second arms. Openings of the first and second arms align with one of a second, third or fourth opening of mounting arm and the bracket is secured into a raised, lowered or level position.

### FIELD OF THE INVENTION

The present invention relates to a welding torch. In particular, the present invention relates to a hex mounting bracket which provides for various positions of a welding gun robotic assembly.

### BACKGROUND OF THE INVENTION

Many types of manufacturing operations require a high degree of precision. In addition, other manufacturing operations require tasks where human activity is inaccessible or hazardous. In such operations a tool or the like is automatically manipulated by a robot machine or gun under program control. The use of robotic machinery increases productivity and profitability for the manufacturer. After constant and regular use, robotic parts may wear and need maintenance; or an occasional crash may occur requiring repair. The time while the robotic machinery is in service, or down time, can critically jeopardize the manufacturer's business.

Robotic assemblies are commonly used with welding guns. Previously, when robotic gun assemblies were dismantled, the down time was extensive because there was no quick and easy means to precisely reassemble the robotic gun. A previous example of a keyed alignment system for a welding torch used with a robotic gun assembly is shown in U.S. Pat. No. 5,451,117 which is hereby incorporated by reference. A mounting arm which provides for various methods of changing position of the welding gun with respect to the robotic arm and the position of the gun with respect to its housing as well as providing easy disassembly of the gun from the robotic arm is needed.

Accordingly, it is considered desirable to provide a mounting arm for a welding gun which allows various positions of the welding gun with respect to the robotic assembly without completely disassembling the robotic assembly.

### SUMMARY OF THE INVENTION

It is accordingly an object of the invention to make it simpler, less expensive and more efficient to change positions of robotic gun assemblies. It is also an object to maintain “down time” of the assembly process at a minimum. Further, it is an object of the invention to reassemble the components of the robotic gun to maintain alignment. To achieve the above objectives, the robotic gun assembly of the invention has a hex mount system that allows replacement of main components without having to remove the entire gun from the robotic arm. The torch has a gooseneck with a hex-shaped sleeve which is locked into position via setscrews. Furthermore, various positions of the gun with respect to the robotic arm assembly can be easily achieved.

In general, the robotic gun assembly includes a gun mounting arm, a gun housing, a nozzle and a gooseneck. In accordance with one aspect of the invention, a mounting apparatus for a welding torch has a bracket having a body having an opening therein; a first arm extending from the body; a second arm extending from the body, the second arm being substantially parallel to the first arm; wherein the opening of the body is adapted to enable an associated welding torch to be mounted in various positions.

In accordance with another aspect of the invention, a mounting assembly for a welding torch has a bracket having a body having an opening for receiving a portion of the torch; first and second members extending from the body, the first and second members are substantially parallel to each other, and each of the members comprises a first opening therethrough. A mounting arm is provided having a first opening therethrough. The mounting arm is received between the first and second arms. A fastener is inserted through the first openings of the members and the first opening of the mounting arm so that the bracket can pivot with respect to the mounting arm about the fastener. The first and second members each comprise a second opening. The mounting arm has second, third and fourth openings. The second openings of the first and second members align with one of the second opening, the third opening and the fourth opening of the mounting arm and is secured into position by a fastener extending through the second openings of the first and second members and one of the second, third and fourth openings of the mounting arm.

In accordance with still another aspect of the invention, a mounting assembly for a welding torch has a bracket having a body with an opening for receiving a portion of a welding torch therein. A first arm and a second arm external from the body, the first and second arms each has at least one opening for receiving a fastener therethrough. A third arm extends from the body and has at least one opening for receiving a fastener. A mounting arm has at least one opening for receiving a fastener therethrough, wherein a fastener is inserted through the opening of the mounting arm and the opening of the third arm.

These and other aspects of the invention will become apparent to those skilled in the art upon reading and understanding the following detailed description of the preferred embodiments taken together with the drawings.

### BRIEF DESCRIPTION OF THE DRAWINGS

The description herein makes reference to the accompanying drawings wherein like reference numerals refer to like parts throughout the several views, and wherein:

FIG. 1 is a side elevational view of the robotic gun assembly displaying a gun mount arm, a gun nozzle, a gooseneck, and the three positions of the gun nozzle, in accordance with an embodiment of the present invention;

FIG. 2 is a front elevational view of the gun hex mount illustrating two positions of the gun nozzle of FIG. 1;

FIG. 3 is a cross-sectional top plan view taken along lines 3-3 of FIG. 1 illustrating a gooseneck having a hex-shaped sleeve;

FIG. 4 is an enlarged side elevational view, in partial cross section, illustrating the robotic arm mount of FIG. 1;

FIG. 5 is an enlarged front elevational view, in cross section, illustrating the hex mount, taken along lines 5-5 of FIG. 4;

FIG. 6 is an exploded perspective view of the hex mount of FIG. 1;

FIG. 7 is a side elevational view of a hex mount for a welding torch in accordance with a second embodiment of the present invention;

FIG. 8 is a front elevational view of the hex mount of FIG. 1 taken along lines 7-7 of FIG. 7; and,

FIG. 9 is an exploded perspective view of the hex mount of FIG. 7.

### DETAILED DESCRIPTION OF THE PREFERRED EMBODIMENTS

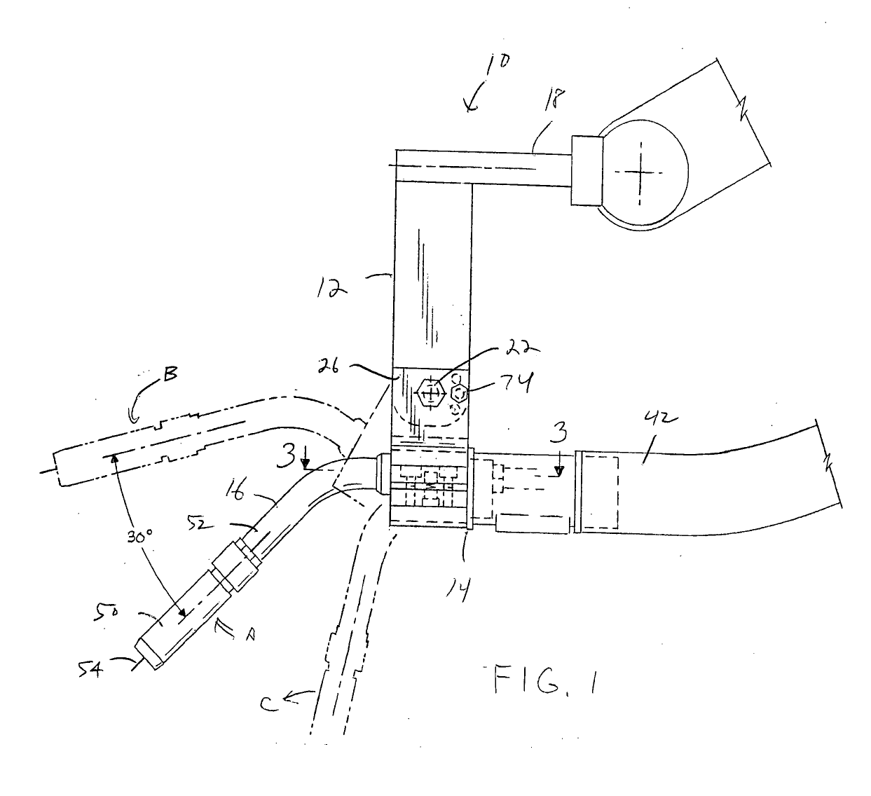

Referring to FIG. 1, a robot machine generally designated by the numeral 10 includes a welding gun mount arm 12, a welding gun housing 14 and a welding torch 16. The gun mount arm 12 is a precision made instrument, typically manufactured from an aluminum alloy, preferably from 6061 aluminum alloy or the like. The gun mount arm 12 of the preferred embodiment is rotatably secured at a distal end 18 to a remote robotic machine (not shown). The gun housing 14 is preferably made of a strong light grade aluminum that is capable of maintaining its shape under tight clamping pressure. The housing may be installed at a first end of the gun assembly or toward a rear end of the gun assembly to provide for various adjustment methods for welding gun positions.

The gooseneck 16 can be an insulated, thick walled copper conductor tube that is wrapped in an aluminum or stainless steel jacket that is capable of dissipating heat quickly. Although the gooseneck 16 as shown in FIG. 1 is bent at a particular angle, the gooseneck may be manufactured to be straight or bent at any desired angle. The robotic gun assembly 10 of the preferred embodiment further comprises a thick walled nozzle 50 machined from hard drawn copper and typically has a highly conductive copper contact tip.

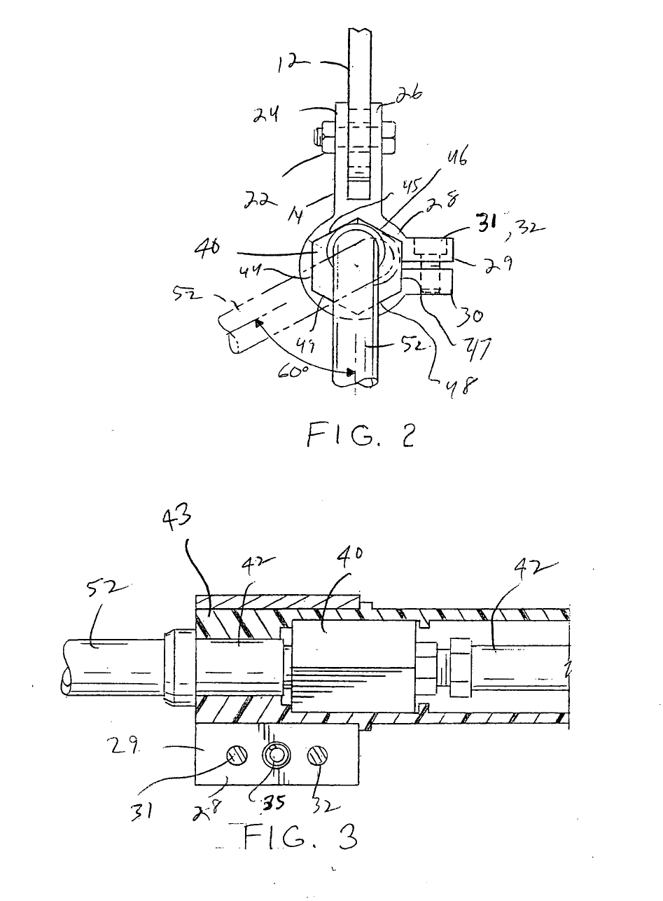

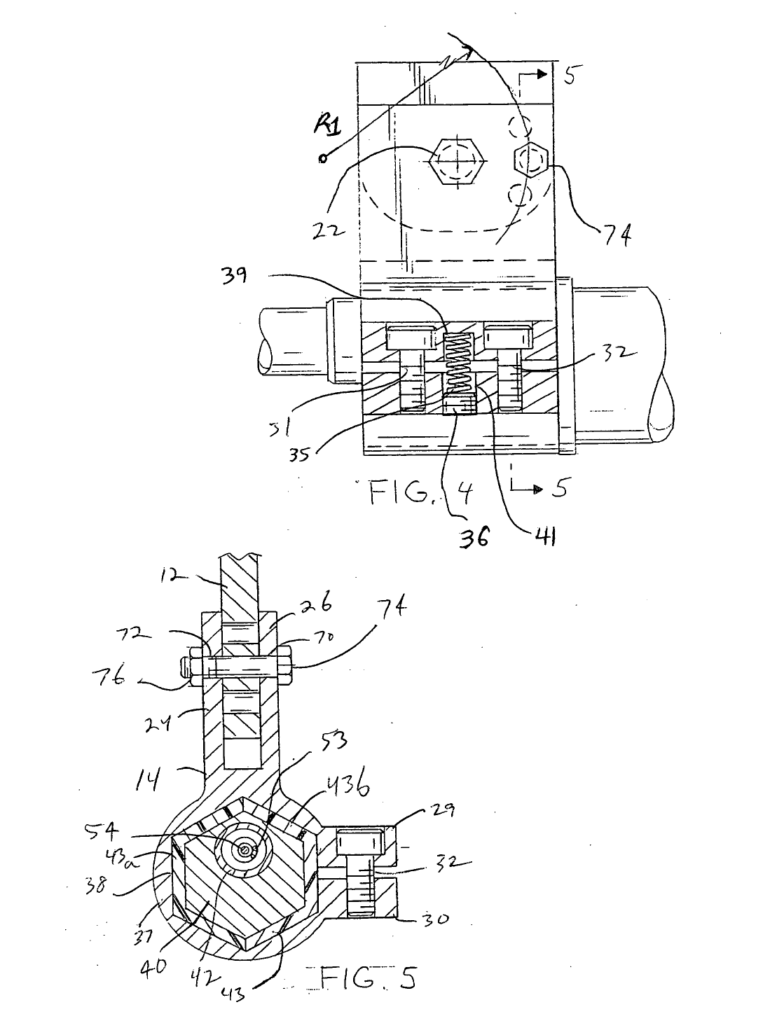

Referring now to FIG. 2, the housing 14 has a clamping portion 28 which has parallel arms 29, 30 held together by a pair of set screws or hex-head capscrews 31, 32 or any appropriate fasteners extending through apertures 33, 34. Referring to FIGS. 3 and 4, a compression spring 35 is interposed between the screws within openings 39 and 41 of arms 29, 30, to allow the clamping arms to move slightly to accommodate various sizes of welding torch nozzles.

The spring allows for rough or approximate adjustment of the two clamping arms. The spring is positioned above a block or plug 36 which secures the spring in position. The bolts or fasteners 31, 32 can be backed off and the spring will expand and the arms will separate slightly until the bolts are re-tightened.

Referring now to FIG. 5, the gun housing 14 has a body 37 which has a hex-shaped opening 38 therein for accommodating a hex-shaped sleeve 40 surrounding a portion of welding nozzle tube 42. Sleeve 40 which is preferably made of brass, further has a plastic protective outer covering 43 on all six sides of the sleeve. Covering 43 has two pieces, 43a and 43b, which are clamped onto the hex sleeve 40 by the inner walls of opening 38 of the housing 14.

Referring to FIGS. 1, 2, and 3, the welding torch 16 has a nozzle portion 50, a gooseneck 52, having a hex-shaped sleeve 40, and a nozzle tube assembly 42. Welding wire 54 extends through the tubing and through the nozzle. A spring or liner 53 surrounds at least a portion of the welding wire.

The hex-shaped sleeve allows for an adjustment of the welding torch to several positions with respect to the housing 14 as shown in FIG. 2. The hex-shaped sleeve is inserted into the hex-shaped opening 38 in one of up to six different positions which changes the position of the gooseneck and the nozzle with respect to the mounting arm by increments of 60 degrees with each rotation to a new position. To change the position of the nozzle and nozzle sleeve, the fasteners 31, 32 are loosened, which in turn separates arms 29, 30 from each other. The nozzle tube 42 and housing 40 are pulled through opening 38 of the body 37 until the hex shaped sleeve is out of opening 38. Then, the nozzle and sleeve are rotated at least 60° or a multiple of 60° to a different position. Then, the sleeve is reinserted into the opening such that edges 44-49 of the sleeve 40 substantially align with the edges 55-59, 61 of opening 38. Then, fasteners 29, 31 are retightened, spring 35 compresses and the nozzle and sleeve are retained in a particular position.

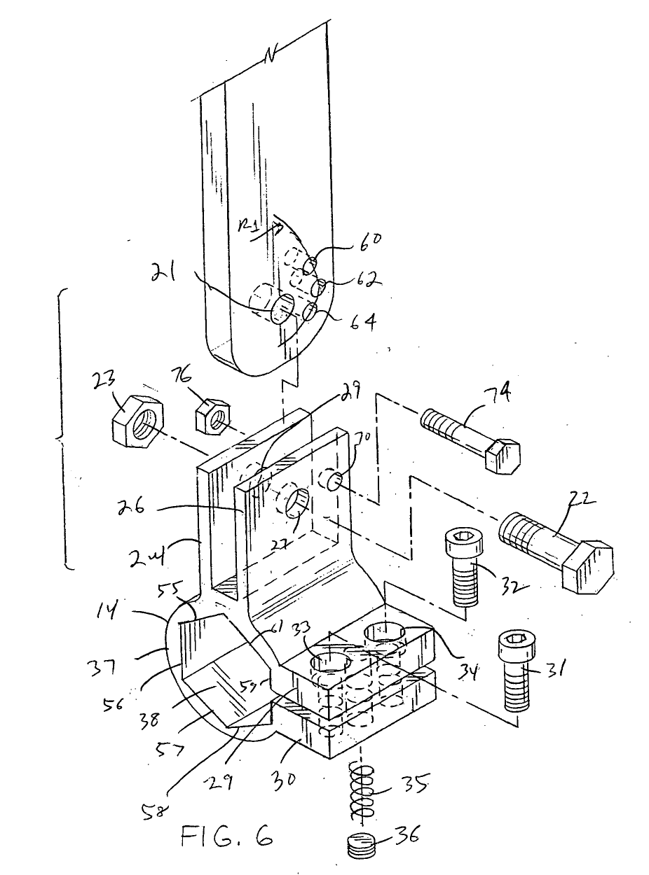

A second adjustment method is provided by the gun housing 14 to adjust the position of the gun housing with respect to the mounting arm. Referring now to FIGS. 1, 4, 5, and 6, the mounting arm 12 has three apertures 60, 62, 64 which are positioned along an arc or radius R₁. The apertures align with corresponding openings 70, 72 in the arms 24, 26 of the housing 14.

To secure the gun housing 14 with respect to the mounting arm 12, a bolt or fastener 74 is placed through holes 70, 72 and one of the holes 60, 62, 64 and secured into place via nut 76. The mounting arm can be placed into one of three positions approximately 30 degrees apart from each other. To rotate the gun housing 14 with respect to the mounting arm 12, nut 76 is loosened and bolt 74 is removed from one of the three holes 60, 62, 64 and holes 70, 72. Then, the gun housing, along with the nozzle, is rotated with respect to the mounting arm and pivoted about bolt 72 within openings 27, 29, and 21 until one of the three openings 60, 62, 64 is aligned with openings 70, 72. Then, bolt 74 is reinserted and nut 76 is threaded onto the end of the bolt.

Referring to FIG. 1, a first, or level, position A for the torch is provided when the center hole 62 of the mounting arm is aligned with holes 70, 72 of the housing 14. To move the torch to a raised position B, the housing is rotated clockwise until openings 70, 72 are aligned with lower opening 64 of the mounting arm 12. To move the torch to a lowered position C, the housing is rotated counterclockwise until the openings 70, 72 are aligned with opening 60.

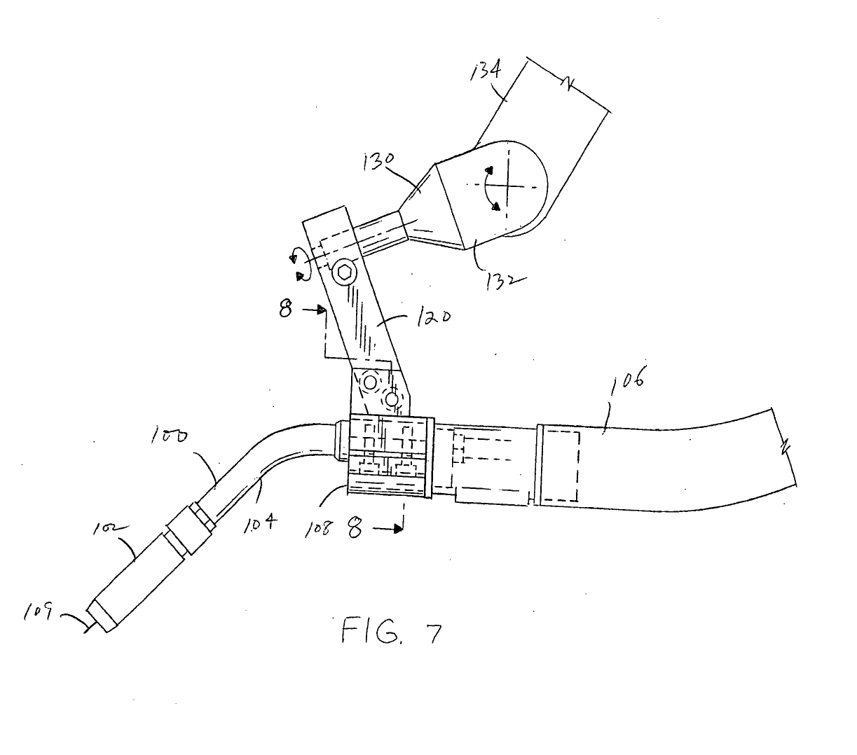

Referring now to FIGS. 7-9, an alternate embodiment of the welding gun hex mount is shown. Referring to FIG. 7, a welding gun torch 100 having a nozzle 102, a gooseneck 104, and a tubular section 106 is attached to and extends through a gun housing 108. A welding wire 109 extends through nozzle 102. A spring or liner 111 surrounds at least a portion of the welding wire. The housing 108, in turn, is connected to a mounting arm 120 of a robotic arm assembly 130. A first, upper arm 132 of the robotic arm assembly is pivotably or rotatably connected to a second, upper arm 134 of the robotic arm assembly. Mounting arm 120 is rotatably mounted to arm 132.

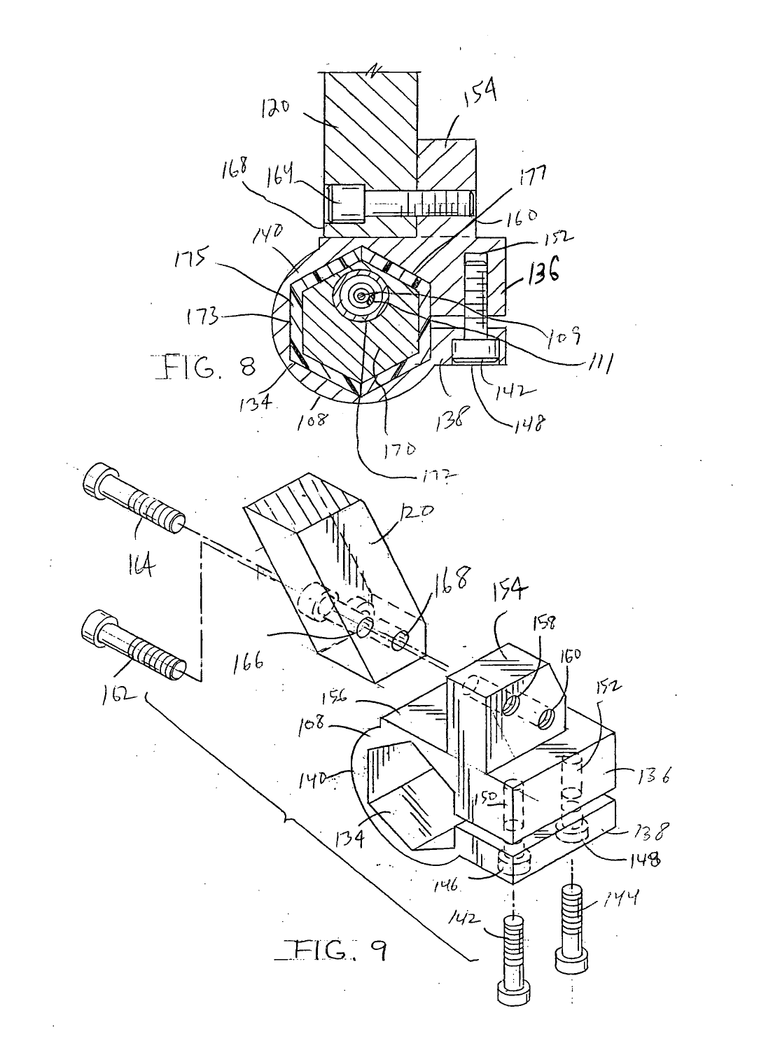

Referring to FIG. 8, gun housing 108 has a hex shaped opening 134. A pair of clamping arms 136, 136 extend from body 140 of the housing and are substantially parallel to each other. A pair of bolts 142, 144 are threaded into holes 146, 148 in arm 136 and holes 150, 152 in arm 138 which are aligned with each other. A third arm 154 extends from an upper surface 156 of body 140. Arm 154 has two holes 158, 160 for receiving bolts or fasteners 162, 164. Mounting arm 120 also has holes 166, 168 for receiving bolts 162, 164. The holes 158, 160 on arm 154 are positioned to align with holes 166, 168 of the mounting arm. The holes are shown to be in a staggered or angled configuration, but other orientations of the openings are also contemplated by the invention. As seen in FIGS. 7-9, there is no adjustment capability provided between the housing 108 and the mounting arm 120.

Referring to FIG. 8, a hex-shaped sleeve 170 is formed on the gooseneck around welding gun tube 172. Sleeve 170 is preferably fabricated from brass and is locked into position in cavity 134. The sleeve has an outer protective layer 173 fabricated from plastic. The outer sleeve 173 is formed from two pieces 175, 177 which are pressed onto sleeve 170 when matingly received by hex-shaped opening 134 in body 108. The welding nozzle and tube can be rotated to one of six positions based on the orientation of the hex-shaped sleeve in the opening 134 as previously explained for the embodiment shown and described in FIGS. 1-6. Once the sleeve is slid into the opening, the clamp arms 136, 138 are secured to each other and retain the sleeve within opening 134.

To change the orientation of the welding nozzle, the bolts 142, 144 are removed and the clamping arms are slightly separated, thus providing a slight increase in area of opening 134, allowing the sleeve 170 to slide through the opening.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A mounting apparatus for a welding torch, comprising:
a bracket comprising:
a body having an opening therein;
a first arm extending from said body;
a second arm extending from said body, said second arm being substantially parallel to said first arm; and,
wherein said opening of said body is adapted to enable an associated welding torch to be mounted in various positions.

2. The mounting apparatus of claim 1, wherein said opening of said body comprises a hex-shaped opening.

3. The mounting apparatus of claim 1, wherein each of said first and second arms comprises at least one opening for receiving a fastener.

4. The mounting apparatus of claim 1, wherein each of said first and second arms comprises an opening for receiving a spring.

5. The mounting apparatus of claim 1, further comprising a plug which is selectively receiving in one of said openings of said arms for receiving said spring.

6. The mounting apparatus of claim 2, wherein said opening of said body comprises a plurality of walls forming said hex-shaped opening.

7. The mounting apparatus of claim 2, further comprising a third arm and a fourth arm extending from said body.

8. The mounting apparatus of claim 7, wherein said third arm and said fourth arm are substantially parallel to each other.

9. The mounting apparatus of claim 7, wherein said third arm and said fourth arm form a channel therebetween.

10. The mounting apparatus of claim 7, wherein each of said third arm and fourth arm comprises a first opening for receiving a fastener.

11. The mounting apparatus of claim 9, further comprises a mounting arm which is selectively received within said channel.

12. The mounting apparatus of claim 11, wherein said mounting arm comprises a first opening for selectively receiving a fastener.

13. The mounting apparatus of claim 12, wherein said mounting arm further comprises second, third and fourth openings for selectively receiving a fastener.

14. The mounting apparatus of claim 13, wherein a center point of each of said second, third and fourth openings are aligned along a common radius about a single point.

15. The mounting apparatus of claim 14, wherein said third and fourth arms each comprises a second opening for selectively receiving a fastener.

16. The mounting apparatus of claim 15, wherein said bracket pivots about a fastener inserted through said first openings of said third and fourth arms and said first opening of said mounting arm.

17. The mounting apparatus of claim 16, wherein said second opening of said mounting arm is aligned with said second openings of said third and fourth arms in a first, or raised position of said bracket.

18. The mounting apparatus of claim 16, wherein said third opening of said mounting arm is aligned with said second openings of said third and fourth arms in a second, or level position of said bracket.

19. The mounting apparatus of claim 16, wherein said fourth opening of said mounting arm is aligned with said second openings of said third and fourth arms in a third, or lowered position of said bracket.

20. The mounting apparatus of claim 17, wherein a fastener is inserted through said second opening of said mounting arm and said second openings of said third and fourth arms to lock the bracket in said raised portion.

21. The mounting apparatus of claim 18, wherein a fastener is inserted through said third opening of said mounting arm and said second openings of said third and fourth arms to lock the bracket in said level position.

22. The mounting apparatus of claim 19, wherein a fastener is inserted through said fourth opening of said mounting arm and said second openings of said third and fourth arms to lock said bracket in said lowered position.

23. A mounting assembly for a welding torch, comprising:
a bracket having a body having an opening for receiving a portion of said torch;
first and second members-extending from said body, said first and second members are substantially parallel to each other, each of said members comprises a first opening therethrough;
a mounting arm having a first opening therethrough;
wherein said mounting arm is received between said first and second arms;
wherein a fastener is inserted through said first openings of said members and said first opening of said mounting arm so that said bracket can pivot with respect to said mounting arm about said fastener;
said first and second members each comprise a second opening;
said mounting arm comprises a second opening, a third opening and a fourth opening; and,
wherein said second openings of said first and second members align with one of said second opening, said third opening and said fourth opening of said mounting arm and is secured into position by a fastener extending through said second openings of said first and second members and one of said second, third and fourth openings of said mounting arm.

24. The mounting apparatus of claim 23, wherein said third arm and said fourth arm are substantially parallel to each other.

25. The mounting apparatus of claim 23, wherein said third arm and said fourth arm form a channel therebetween.

26. The mounting apparatus of claim 23, wherein a center point of said second, third and fourth openings are each aligned along a common radius about a point.

27. The mounting apparatus of claim 23, wherein said second opening of said mounting arm is aligned with said second openings of said third and fourth arms in a first, raised position of said bracket.

28. The mounting apparatus of claim 23, wherein said third opening of said mounting arm is aligned with said second openings of said third and fourth arms in a second, level position of said bracket.

29. The mounting apparatus of claim 23, wherein said fourth opening of said mounting arm is aligned with said second openings of said third and fourth arms in a third, lowered position of said bracket.

30. The mounting apparatus of claim 27, wherein a fastener is inserted through said second opening of said mounting arm and said second openings of said third and fourth arms to lock the bracket in said raised portion.

31. The mounting apparatus of claim 28, wherein a fastener is inserted through said third opening of said mounting arm and said second openings of said third and fourth arms to lock the bracket in said level position.

32. The mounting apparatus of claim 29, wherein a fastener is inserted through said fourth opening of said mounting arm and said second openings of said third and fourth arms to lock said bracket in said lowered position.

33. A mounting assembly for a welding torch, comprising:
a bracket comprising:
a body having an opening for receiving a portion of a welding torch therein;
a first arm and a second arm extending from said body, said first and second arms each having at least one opening for receiving a fastener therethrough;
a third arm extending from said body, said third arm has at least one opening for receiving a fastener; and,
a mounting arm having at least one opening for receiving a fastener therethrough, wherein a fastener is inserted through said opening of said mounting arm and said opening of said third arm.

34. The mounting apparatus of claim 33, wherein said opening of said body comprises a hex shaped opening.

35. The mounting apparatus of claim 34, wherein said opening of said body comprises a plurality of walls forming said hex-shaped opening.

36. The mounting assembly of claim 33, wherein said first and second arms each comprises a second opening for selectively receiving a fastener.

37. The mounting assembly of claim 33, wherein said third arm comprises a second opening for selectively receiving a fastener.

38. The mounting assembly of claim 37, wherein said mounting arm comprises a second arm for selectively receiving a fastener.
